(19) United States
(12) Patent Application Publication
(10) Pub. No.: US 2026/0203779 A1
(43) Pub. Date: Jul. 16, 2026

(54) INTERACTION ANALYSIS USING SYNTHETIC INTERACTION DATA

(71) Applicant: Walmart Apollo, LLC, Bentonville, AR (US)

(72) Inventors: Dong Xu, Sunnyvale, CA (US); Chaowen Zheng, Fremont, CA (US); Yuan Feng, Los Altos, CA (US); Hangjian Li, Issaquah, WA (US); Kuang-chih Lee, Fremont, CA (US); Wei Shen, Pleasanton, CA (US); Ka Wai Yung, San Francisco, CA (US); Xiangyu Zhang, San Jose, CA (US); Zhuoying Li, San Jose, CA (US); Zehao Wang, San Jose, CA (US); Dhayanand Shunmugam, Pleasanton, CA (US); Yesudason Paulraj, Monmouth Junction, NJ (US); Sreeram Reddy Kasarla, Fremont, CA (US); Sam Hien-Pham Ho, Hayward, CA (US); Stewart C. Lin, San Mateo, CA (US)

(21) Appl. No.: 19/447,865

(22) Filed: Jan. 13, 2026

Related U.S. Application Data
(60) Provisional application No. 63/745,209, filed on Jan. 14, 2025.

(51) Int. Cl. G06Q 30/0201

(52) U.S. Cl. CPC G06Q 30/0201

(57) ABSTRACT

Example implementations relate to generating an interaction analysis that includes receiving interaction data for an interface element included in a user interface during a time period coinciding with an interaction campaign. If an initial automated analysis of the interaction data does not meet a first predetermined threshold, a set of time series features are generated for at least a portion of the time period. Synthetic interaction data for the interface element are generated during at least the portion of the time period. The synthetic interaction data represents interactions with the interface element independent of the interaction campaign and is generated by a time series model that receives the set of time series features. A difference metric for the interaction data and the synthetic interaction data is determined and if the difference metric is above a second predetermined threshold, the difference metric is stored in a database.

### CROSS REFERENCE TO RELATED APPLICATION

This application claims benefit to U.S. Provisional Patent Application No. 63/745,209, entitled “INTERACTION ANALYSIS USING SYNTHETIC INTERACTION DATA,” filed on Jan. 14, 2025, the disclosure of which is incorporated herein by reference in its entirety.

### TECHNICAL FIELD

This application relates generally to interaction analysis, and more particularly, to performing interaction analysis using one or more time series features.

### BACKGROUND

An application on a user device, such as a smartphone, may display an interactive interface. User interactions with an interactive interface may be logged and analyzed to determine the effectiveness of interaction elements over a period of time. Such analysis may be utilized for improving deployment of interface elements.

### BRIEF DESCRIPTION OF THE DRAWINGS

Various examples will be described below with reference to the following figures.

FIG. 1 depicts an example system that provides user interaction analysis, in accordance with some embodiments.

FIG. 2 depicts an example system that generates a user interaction analysis, in accordance with some embodiments.

FIG. 3 depicts an example process flow for generating and selecting time series feature data, in accordance with some embodiments.

FIG. 4 depicts an example time series feature set, in accordance with some embodiments.

FIG. 5 depicts a flowchart of an example method for performing interaction analysis, in accordance with some embodiments.

FIG. 6 depicts an example system with a machine-readable medium that includes instructions to generate an interaction analysis, in accordance with some embodiments.

FIG. 7 depicts an example computer system that implements one or more processes, in accordance with some embodiments.

### DETAILED DESCRIPTION

The disclosed systems and methods enable generation of a user interaction analysis which provides interaction insight regarding how users interact with interface elements. The disclosed systems and methods generate synthetic interaction data for users who are not exposed to certain interface elements to compare to interaction data for users who were exposed to the corresponding interface elements. The disclosed systems and methods may determine what catalog items users purchased and/or interacted with during an interaction campaign, how users interacted with those same items prior to the interaction campaign, and predict how the users would have interacted with those catalog items had they not been exposed the campaign. Such predictions provide for improved interfaces by identifying elements having a high interaction for deployment or modeling. Furthermore, in some embodiments, the disclosed systems and methods provide a computer-implemented process for determining causal effects of non-randomized interface presentations by applying counterfactual predictions to determine differences between expected and actual outcomes. For example, determining how effective a sales campaign over time via a set of non-randomized data points is challenging and the counterfactual prediction model can address this challenge. These and other advantages will be apparent from the disclosure herein.

In various embodiments, a system for interaction analysis is disclosed. The system includes a processor and non-transitory memory that stores instructions. The instructions, when executed, cause the processor to receive interaction data for at least one interface element included in a user interface during a time period coinciding with an interaction campaign. The instructions further cause the processor, in response to determining that an initial automated analysis of the interaction data does not meet a first predetermined threshold, to generate a set of time series features for at least a portion of the time period and generating synthetic interaction data for the at least one interface element during at least the portion of the time period. The synthetic interaction data represents interactions with the at least one interface element independent of the interaction campaign and is generated by a time series model that receives the set of time series features. The instructions further cause the processor to determine a difference metric for the interaction data and the synthetic interaction data and, in response to determining the difference metric is above a second predetermined threshold, store the difference metric in a database.

In various embodiments, a computer-implemented method is disclosed. The computer-implemented method includes steps of receiving interaction data for at least one interface element included in a user interface during a time period coinciding with an interaction campaign, in response to determining that an initial automated analysis of the interaction data does not meet a first predetermined threshold, generating a set of time series features for at least a portion of the time period, and generating synthetic interaction data for the at least one interface element during at least the portion of the time period. The synthetic interaction data represents interactions with the at least one interface element independent of the interaction campaign and is generated by a time series model that receives the set of time series features. The computer-implemented method further includes steps of determining a difference metric for the interaction data and the synthetic interaction data and, in response to determining the difference metric is above a second predetermined threshold, storing the difference metric in a database.

In various embodiments, a non-transitory computer-readable medium having instructions stored thereon is disclosed. The instructions, when executed by a processor, cause a device to perform operations including receiving interaction data for at least one interface element included in a user interface during a time period coinciding with an interaction campaign, in response to determining that an initial automated analysis of the interaction data does not meet a first predetermined threshold, generating a set of time series features for at least a portion of the time period, and generating synthetic interaction data for the at least one interface element during at least the portion of the time period. The synthetic interaction data represents interactions with the at least one interface element independent of the interaction campaign and is generated by a time series model that receives the set of time series features. The instructions further cause the device to perform operations including determining a difference metric for the interaction data and the synthetic interaction data and, in response to determining the difference metric is above a second predetermined threshold, storing the difference metric in a database.

This description of the example embodiments is intended to be read in connection with the accompanying drawings that are to be considered part of the entire written description. Terms concerning data connections, coupling and the like, such as “connected” and “interconnected,” and/or “in signal communication with” refer to a relationship wherein systems or elements are electrically connected (e.g., wired, wireless, etc.) to one another either directly or indirectly through intervening systems, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these example embodiments in connection with the accompanying drawings.

Furthermore, in the following, various embodiments are described with respect to methods and systems for generating an interaction analysis based on one or more user's interactions with user interface elements. In various embodiments, the system receives interaction data for at least one interface element included in a user interface during a time period coinciding with an interaction campaign. In response to determining that an initial automated analysis of the interaction data does not meet a first predetermined threshold, a set of time series features for at least a portion of the time period are generated. Synthetic interaction data for the at least one interface element during at least the portion of the time period is generated from the set of time series features. The synthetic interaction data represents interactions with the at least one interface element independent of the interaction campaign and is generated by a time series model that receives the set of time series features. A difference metric for the interaction data and the synthetic interaction data is determined and, in response to determining the difference metric is above a second predetermined threshold, the difference metric is stored in a database.

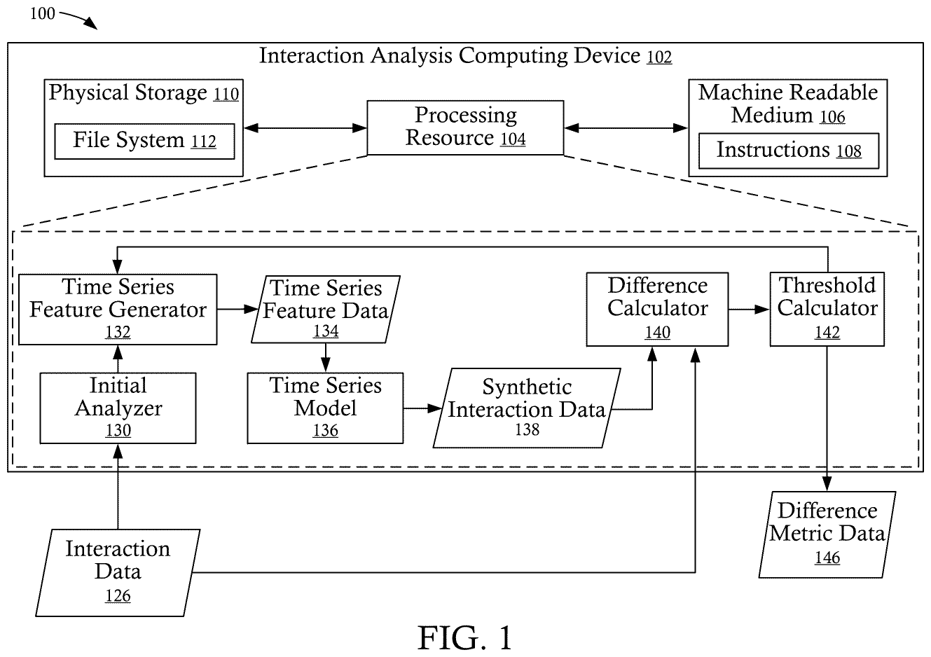

FIG. 1 depicts an example system 100 that provides an interaction analysis, in accordance with some embodiments. The system 100 includes an interaction analysis computing device 102 that provides an interaction analysis. The interaction analysis computing device 102 includes a processing resource 104 that may include one or more microcontrollers, microprocessors, field-programmable gate arrays (FPGAs), application-specific integrated circuits (ASICs), state machines, digital circuitry, and/or any other suitable processing resource. The interaction analysis computing device 102 includes a non-transitory machine-readable medium 106 that may include one or more of a random-access memory (RAM), read-only memory (ROM), electrically erasable programmable read-only memory (EEPROM), flash memory, hard disk, and/or any other suitable memory resource.

The processing resource 104 may execute instructions 108 (i.e., programming or software code) stored on machine-readable medium 106 to perform functions of the interaction analysis computing device 102, such as generating an interaction analysis based on one or more user's interactions with catalog items. The instructions 108 may include instructions for implementing one or more models. In some embodiments, and as will be described further herein below, the interaction analysis computing device 102 may execute one or more models, processes, or algorithms, such as a machine learning model, deep learning model, statistical model, etc., (e.g., as implemented as machine readable instructions) to generate the interaction analysis and output the results to a user.

The interaction analysis computing device 102 may also include other hardware components, such as physical storage 110. Physical storage 110 may include any physical storage device, such as a hard disk drive, a solid-state drive, or the like, or a plurality of such storage devices (e.g., an array of disks), and may be locally attached (e.g., installed) in the interaction analysis computing device 102. In some implementations, physical storage 110 may be accessed as a block storage device.

In some cases, the interaction analysis computing device 102 may also include a local file system 112 that may be implemented as a layer on top of the physical storage 110. For example, an operating system may be executing on the interaction analysis computing device 102 (by virtue of the processing resource 104 executing certain instructions 108 related to the operating system) and the operating system may provide a file system 112 to store data on the physical storage 110.

The interaction analysis computing device 102 may be in communication with one or more additional devices over one or more network channels. For example, in various embodiments, the interaction analysis computing device 102 may be in communication with a web server, a cloud-based engine including one or more processing devices that may be provisioned for use, a database, a workstation, and/or any other suitable system or device. The interaction analysis computing device 102 may similarly be in communication, either directly or indirectly, with one or more user computing devices operatively coupled over the network. The other computing systems may be similar to the interaction analysis computing device 102, and may each include at least a processing resource and a machine readable medium.

In some embodiments, a user submits a query on a website, for example, hosted by a web server. The web server may send a campaign interaction request to the interaction analysis computing device 102. The campaign interaction request may include interaction data 126. In response to receiving the campaign interaction request, the interaction analysis computing device 102 may execute one or more processes to determine the relevant interaction campaign and transmit the results including suggestions for one or more catalog items related to the interaction campaign to the web server to be displayed to the user. For example, a user may include a campaign manager who sends a query to a web server inquiring about one or metrics of an interaction campaign, such as an on-going campaign or a prior campaign. For example, in one non-limiting example a query may include a request for one or more sales lift reports and the response from the web server includes one or more sales lift report that have been verified based on the disclosed systems and methods and which include data points indicating the success of the corresponding campaign. The data points may include campaign interaction points when different frontend users participate in the scheduled campaign in at least one way such as searching an item part of the campaign, interacting with an item part of the campaign (e.g., clicking on a catalog item), adding the participating item to a cart, etc.

In some embodiments, an initial analyzer 130 receives interaction data 126 and performs analysis to determine when the interaction data meets a predetermined threshold. For example, the predetermined threshold may include an error range and the initial analyzer 130 may determine when the error of the interaction data 126 is within the predetermined error range. In some embodiments, when there is not enough data at the specified point it time, the initial analyzer 130 may generate an error range outside the predetermined threshold and the interaction data 126 may be analyzed using synthetically generated interaction data as described herein.

In some embodiments, the interaction data 126 is representative of user interactions with one or more user interfaces, such as, for example, click rate, purchase rate, exposure to interaction campaigns, interactions with the system, etc. In some embodiments, the interaction data may be grouped based on types of interactions, item-related interactions, and/or any other suitable grouping. Additionally, the interaction data may be associated with a time series such that each interaction with an item and/or a user may be mapped on a timeline corresponding to when the interaction occurred. One or more reference points may be chosen to generate a time series. For example, a first point of reference may include when an interaction campaign started. Thus, a first interaction (e.g., a click, a purchase, etc.) a user has with an item could occur prior to the start of the interaction campaign, during the interaction campaign or after the interaction campaign. As another example, a second point of reference may include an item being added after the point in time when the interaction campaign began.

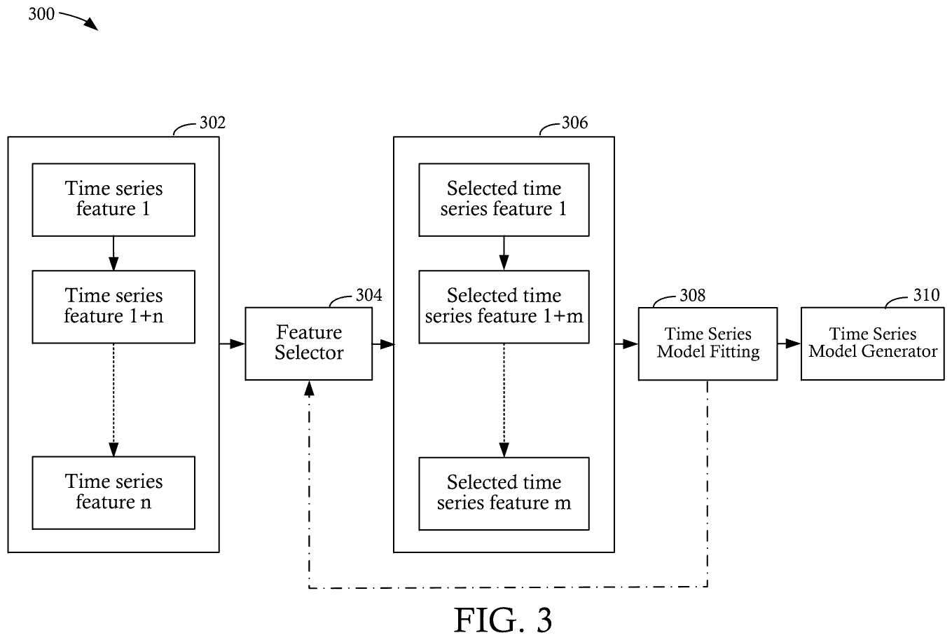

In some embodiments, the time series feature generator 132 generates two or more time series features associated with the interaction data 126. The time series features may include, but are not limited to, an item click rate, a purchase rate, a user interaction, etc. The generated time series features may be represented as time series feature data 134. An example implementation of time series feature generator 132 is described further herein below with reference to FIG. 3

In some embodiments, the time series feature data 134 includes a plurality of time series data points, action, and/or user spend. In one illustrative example, each data element in a set of time series feature data 134 may be related to an item (e.g., a quantity of times the item was purchased by a quantity of users and at what point in time those actions occurred). When graphed over time the time series feature data 134 may illustrate that, during a specific period of time, there is an increased interaction or a decreased interaction. In another example, a set of time series feature data 134 may include an amount of times an item was put in a user's cart or the amount of times an item was clicked on during a certain time period. Thus, when graphed over time, a visual indicating a rise or drop in clicking and/or adding the item to the cart is displayed. The time series feature data 134 further includes whether or not a customer was exposed to a particular interaction campaign and if the customer was eligible to be exposed to the interaction campaign but was not actually exposed.

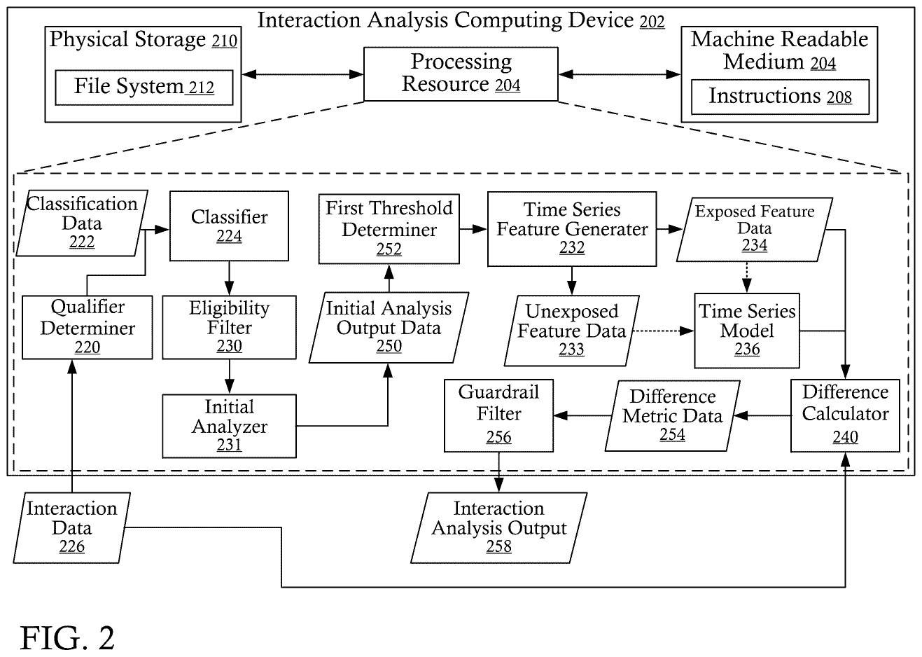

In some embodiments, a time series model 136 receives the time series feature data 134 and using a subset of the time series feature data 134, generates the time series model 136. The time series model 136 selects the subset of the time series feature data 134 and produces the model based on that subset of the time series feature data 134. Furthermore, the time series model 136 uses the time series feature data 134 for generation and during analysis. In some embodiments, the time series model 136 may include a counterfactual prediction model generated using exposed and/or unexposed feature data as further discussed below with respect to FIG. 2.

In some embodiments, the time series model 136 produces synthetic interaction data 138 based on a determined mathematical representation to convert exposed users into unexposed users. The synthetic interaction data 138 may represent a counterfactual prediction of a plurality of users'behavior had the corresponding users not been exposed to a particular interaction campaign. The synthetic interaction data 138 may include data representative of the two or more time series features where a user who is eligible to be exposed to an interaction campaign has not been exposed to an interaction campaign, e.g., predicting interaction data 126 had eligible users not been exposed to the corresponding interaction campaign. Synthetic interaction data 138 may include, but is not limited to, the data output by the time series model 136 and representative of a plurality of users behavior and user exposure (or lack thereof) to the campaign.

In some embodiments, a difference calculator 140 receives the synthetic interaction data 138 and interaction data 126 and performs a difference calculation between actual interactions of user interaction with catalog items during the campaign time period contained in the interaction data 126 and predicted counterfactual interactions during the campaign time period represented by the synthetic interaction data 138. The output of the difference calculator 140 may include multiple calculations between synthetic interaction data 138 and interaction data 126 including, for example, matching quality, curve drop, maximum gap, and a ratio of the two.

The threshold calculator 142 receives the one or more difference calculations from the difference calculator 140 and determines if each calculation satisfies the threshold. The threshold calculator 142 stores the calculations and their threshold values in the difference metric data 146. In some embodiments, the difference metric data 146 is utilized to analyze the efficiency of interaction campaigns, for example, by providing a metric indicating the difference of interactions generated by presentation of the interaction campaign. The different metric data 146 may be in the form and/or incorporated into one or more interfaces or reports that may be provided to additional processes or systems.

FIG. 2 depicts an example system that analyzes interaction data, in accordance with some embodiments. In some cases, the interaction analysis computing device 202 may also include a local file system 212 that may be implemented as a layer on top of the physical storage 210. For example, an operating system may be executing on the interaction analysis computing device 202 (by virtue of the processing resource 104 executing certain instructions 208 related to the operating system) and the operating system may provide a file system 212 to store data on the physical storage 210.

In some embodiments, interaction data 226 is received. The interaction data 226 is similar to the interaction data 126 discussed with respect to FIG. 1, and similar description is not repeated herein. The interaction data 226 includes data reflective of user interactions with the system and/or one or more catalog items (e.g., items included on an ecommerce interface), click rate and/or purchase rate for catalog items, a user's exposure or lack thereof to an interaction campaign, user interaction data and item interaction data, etc. The interaction data 226 further includes one or more catalog items and interaction campaign data, etc.

In some embodiments, the qualifier determiner 220 receives interaction data 226 and determines when the one or more data points are eligible to be classified by the classifier 224. For example, the qualifier determiner 220 may determine when one or more catalog items are new items and/or high or low velocity items and when the interaction campaign data indicates whether or not the campaign is a high spend or low spend campaign. In some embodiments, an input for the classifier 224 is only produced if the one or more catalog items and interaction campaign data meet a certain criterion. In one example, the criteria require high velocity items and/or the campaign is a high spend campaign. In that example, if the threshold is not met, the data is filtered out and not sent to the classifier 224.

In some embodiments, the classification data 222 includes data with attributes that associate one or more data points in the interaction data with a classic campaign and/or a seasonal campaign. The classification data 222 also includes a time period for the classic/seasonal campaigns such that the respective interaction data point can be properly assigned and an analytical period can be determined.

In some embodiments, the classifier 224 receives one or more qualified interaction data points from the qualifier determiner 220 and classification data 222. Based on the classification data 222 the one or more qualified interaction data points are assigned a campaign type. For example, the campaign type may be determined based on an item's sales pattern. For example, if the item is only sold seasonally (e.g., Valentines Day, Mother's Day, etc.), a seasonal campaign designation is assigned. In contrast, an everyday item (e.g., candy) with the possibility of being a part of multiple campaigns (e.g., Halloween, Valentines Day, etc.) is given a classic campaign designation. The classification data includes one or more items including their sales patterns and corresponding campaign data for each of the one or more items. In another example, a user interaction data point (e.g., a user clicking on a catalog item) might be associated with a campaign based on whether or not the user is exposed to the campaign and/or the catalog item is in a campaign.

Once a campaign type is assigned to each respective qualified interaction data point, an analytical period is determined. In some embodiments, an analytical timeframe associated with the campaign type is assigned to determine the period of time item data patterns can be analyzed for the respective campaign. Different campaigns require different analytical time frames to ensure the item sales patterns are long enough to provide a comprehensive data set for the predicted group. For example, if a campaign is designated as seasonal, a time period of 12-24 months may be assigned as the campaign may run only once a year and multiple time periods are required to gather enough data to determine item sales patterns. In another example, for a classic campaign including items which are sold more regularly, a time period of 3-9 months may be assigned as there is likely enough data to determine an item sales pattern for each of the respective items in the classic designated campaign. For example, catalog items/user interactions (e.g., buying napkins) assigned with classic campaigns likely include more data points as the items/interactions are occurring more regularly. In contrast, items sold in seasonal campaigns (e.g., Valentine's Day cards, Halloween Candy, etc.) likely require a longer analytical period to capture enough data points as the time frame is much shorter for those campaigns and thus multiple seasons are required to be captured.

In some embodiments, the eligibility filter 230 receives the classified data from the classifier 224 and further determines a subset of the data considered eligible for further processing. The eligibility filter 230 operates to provide high quality data points to the initial analyzer 231. For example, when selecting which user interactions to use, selecting the user interactions where the user was exposed to the campaign would be preferable than using user interactions where the user was not exposed (or ineligible) to receive the campaign notification. Thus, the eligibility filter 230 filters the data before sending it to the initial analyzer 231.

In some embodiments, an overlapping campaign adjustment is made to adjust the counterfactual prediction by removing the effect of overlapping campaigns on the results. For example, if Easter candy and Mother's Day candy are both marketed at the same time, but the targeted campaign is only Easter, the Mother's Day results should be removed to not include poor results. Thus, removing data points that might be over inflated due to overlapping campaigns is essential to keeping maintaining the integrity of the output and ensuring a correct, accurate, and uninflated result.

In some embodiments, the initial analyzer 231 includes features analogous to those described with respect to the initial analyzer 130 discussed in FIG. 1. The initial analyzer 231 receives the eligible classified data from eligibility filter 230 and outputs the initial analysis output data 250. The initial analyzer 231 uses the eligible classified data and performs an exposure model. The exposure model determines if the eligible classified data incorporates data points where a first set of users are exposed to the assigned campaign and a second set of users are not exposed to the assigned campaign. The eligible classified data includes user impressions, page view features, and a plurality of users. In parallel a feature aggregation model is run using campaign impressions, daily sales, transactions, etc. A combination of the output of the exposure model and the feature aggregation model are used to sample and match the data ultimately outputting interaction metrics.

In some embodiments, the initial analysis output data 250 includes the interaction metrics output from the initial analyzer 231. The interaction metrics include one or more metrics representative of both exposed and unexposed users to a particular campaign. The initial analysis output data 250 further includes test and control curve matching quality, relative control curve drop (e.g., those exposed to the campaign), the maximum gap between the test and control curves, and a ratio of the total incremental value between the those exposed to the campaign and those not exposed.

In some embodiments, the first threshold determiner 252 analyzes each data point in the initial analysis output data 250 and determines if the data point is within an acceptable threshold or outside of the threshold. For example, if the gap between the text and control curves is too large and therefore likely to be unrealistic, then the results are sent for further processing to the time series feature generator 232. In some embodiments, if all of the data points satisfy the threshold, then no further data processing is required and a result is output to the user. If any of the data points are outside of the threshold, all of the data points are sent for further processing to bring the metrics within the predetermined threshold when output from the system.

In some embodiments, the time series feature generator 232 includes analogous features to the time series feature generator 132 illustrated and discussed in FIG. 1, and an example implementation is described further herein below with reference to FIG. 3. Based on the eligible classified data and the initial analysis output data 250, a plurality of time series features are generated. A time series feature can include the click rate and/or purchase rate of a catalog item that is selected to be part of a campaign (e.g., how many users clicked on Valentine's Day cards). Time series features can also include user interactions with catalog items, campaigns, etc. For the selected campaign, a plurality of time series features are generated such that the most relevant subset can be selected in additional processing steps discussed below.

In some embodiments, the unexposed feature data 233 includes time series feature data points that include users who have not been exposed to a respective campaign. Additionally, unexposed feature data 233 includes analogous features to the time series feature data 134 illustrated and discussed in FIG. 1. For example, when determining the counterfactual prediction to compare the interaction amount of a user with catalog items in a campaign, a comparison between users exposed to campaigns and unexposed to campaigns provides a more accurate look at the effectiveness of the campaign on the user's interactions with catalog items.

In some embodiments, the exposed feature data 234 includes time series feature data points that include users who have been exposed to a respective campaign. Additionally, exposed feature data 234 includes analogous features to the time series feature data 134 illustrated and discussed in FIG. 1. Additionally, the exposed feature data 234 includes analogous features to the unexposed feature data 233 discussed above with the difference that the data includes only user's exposed to the respective campaign.

In some embodiments, the time series model 236 includes analogous features to the time series model 136 discussed and illustrated in FIG. 1. In some embodiments, the time series model 236 receives exposed feature data 234 and generates a counterfactual prediction model representative of a mathematical representation for what the interaction with one or more catalog items would be had those same user's not been exposed to the respective campaign. In some embodiments, the mathematical representation may be generated using the exposed feature data 234 to provide a more accurate representation because there are more data points with the users that are directly relevant to the prediction. In some embodiments, the unexposed feature data 233 is compared to the exposed feature data 234 and the time series model 236 is generated using both types of data. In some embodiments, the unexposed feature data 233 is used to generate the time series model, such that the difference calculator 240 uses the exposed feature data 234 to calculate the difference compared to the unexposed feature data 233. The times series model 236 may be campaign specific and may be generated based on corresponding exposed and unexposed feature data 233 and 234 for the respective campaign. For example, when a campaign is for a predetermined time period, such as a time period corresponding to Valentine's Day, a campaign specific time series model 236 may be generated based on data for the specific Valentine's Day campaign as opposed to using a time series model 236 for a previous campaign, such as, for example, a Black Friday campaign.

In some embodiments, the time series model 236 selects a subset of the time series features generated in the time series feature generator 232 and stored in the exposed and unexposed feature data 233 and 234 respectively. This is further discussed with respect to FIG. 3 below.

In some embodiments, the difference calculator 240 includes features analogous to those discussed with respect to the difference calculator 140 illustrated and discussed in FIG. 1. The difference calculator receives the exposed feature data 234, unexposed feature data 233, and the time series model 236 and performs the difference between the counterfactual interactions (e.g., synthetic interaction data, such as for example synthetic interaction data 138, which is representative of what the user interactions would be with one or more catalog items without exposure to the respective campaign) with the actual interactions (e.g., which are included in the exposed feature data 234). In some embodiments, multiple calculations are performed and stored in the difference metric data 254 such that each of the calculations stored in the data can be prepared to provide the most accurate output to the system.

In some embodiments, the difference metric data 254 includes data representative of the difference calculations provided by the difference calculator 240. Additionally, the difference metric data 254 includes analogous features to the difference metric data 146 illustrated and described in FIG. 1. For example, the difference metric data 254 includes the mathematical representation in the time series model 236 which is generated using the exposed feature data 234 to predict users interactions as if the users were not exposed to the respective campaign. Furthermore, the difference calculator determines the difference of the actual interactions stored in the exposed feature data 234 and the output of the time series model 236 which includes the counter factual prediction model applied to the exposed feature data 234 (e.g., synthetic interaction data). In another example, the unexposed feature data 233 is used to generate the time series model 236 such that the difference calculator 240 receives the exposed feature data 234 to provide the actual measured interactions in the difference calculator 240 and the output of the time series model 236 provides the counterfactual prediction using similar (but not the same) users. In some embodiments, similar users include users that are eligible to be exposed to the respective campaign but were not and had interactions with catalog items associated with the respective campaign. These unexposed users are used as a control group. The difference metric data 254 can include multiple calculations with respect to the control group of users and the actual group of users including the matching quality, the curve drop, the maximum gap, and the ratio of the two.

In some embodiments, the guardrail filter 256 includes one or more quantitative metrics to verify the quality of the output and that the output is maintained within a certain threshold. The guardrail filter 256 checks the discrepancies between the control and test group. If the discrepancies between the control and test group are above a predetermined threshold, then the prediction may be deemed deficient and a different time series model may need to be generated. The guardrail filter is performed automatically for efficiency and to allow several more checks to be processed than if it was done manually. A first example includes two metrics that evaluate discrepancy between the control group and the test group which includes the overall test and control curve matching quality and the maximum gap between the test and control interaction curves. For example, if the gap between the two curves (or data points) is too large, the discrepancy may be deemed too large and the prediction may be beyond the recommended threshold which renders the output invalid. A second example includes reviewing the control curve drop. If the drop is outside of the threshold, then there may be an issue with the data and the control may not be an effective measure. Therefore, the guardrail filter 256 evaluates the control curve drop to determine that it is within a threshold. A third example includes the ratio of total incremental interactions to the total catalog item set which indicates whether or not the results are over inflated. For example, if the test group is significantly higher than the control group, then the results may look inflated and not provide an accurate output. Thus, the guardrail filter 256 may control the ratio to be within an acceptable threshold to provide an accurate output.

In some embodiments, the interaction analysis output 258 includes data that provides interaction analysis prior, during, and after to the start of the campaign with the granularity of the control group and test group within the specified thresholds. The interaction analysis output 258 includes an accurate representation of the interaction analysis of a control and test group such that the relative success of a campaign can be determined and effectively used future campaigns. The interaction analysis output 258 is provided to a user (or group of users) via software, graphs, data points that can be extrapolated for something else, and/or via a user interface that can be manipulated by a user.

FIG. 3 is a flowchart 300 illustrating a process of generating and selecting time series feature data, in accordance with some embodiments. A time series feature generator 302 includes elements analogous to the time series feature generator 132 and 232 illustrated and described in FIGS. 1-2. The time series feature generator 302 generates a plurality of time series features related to a respective interaction campaign being analyzed, for example, based on provided interaction data. One or more generated time series features may be received by feature selector 304. The feature selector 304 determines which of the one or more time series features should be utilized to generate a time series model. The selected time series features may be stored as a selected set of time series feature data 306. In some embodiments, the functions of the feature selector 304 may be performed by one or more models, such as the time series models 136 and 236, and/or as separate functions prior to generation of the time series models 136 and 236. The time series feature data 306 includes analogous features to the time series feature data 134 described in FIG. 1 and the exposed and unexposed feature data 234 and 233 as described in FIG. 2.

In some embodiments, time series model fitting 308 is performed on the selected time series features to determine whether that the selected time series features fit a corresponding time series model. When the selected time series features are not a fit to the corresponding time series model, the feature selector 304 may be reimplemented to select a different set of time series features. Alternatively, when the selected time series features are a fit to the corresponding time series model, the time series model may be generated via a time series model generator 310, which generates a time series model that includes analogous features to the time series model 236 and time series model 136 described above. In some embodiments, when the time series features are selected, the test counter factual prediction should: (i) be close to the test observed time series prior to the interaction campaign start (e.g., the pre-campaign period), (ii) not drop too much in contrast to the test observed time series at the beginning of the in-campaign period, and (iii) lead to a consistent result on multiple channels (online versus catalog). The selected time features include a combination that can generate the most trustworthy counterfactual prediction.

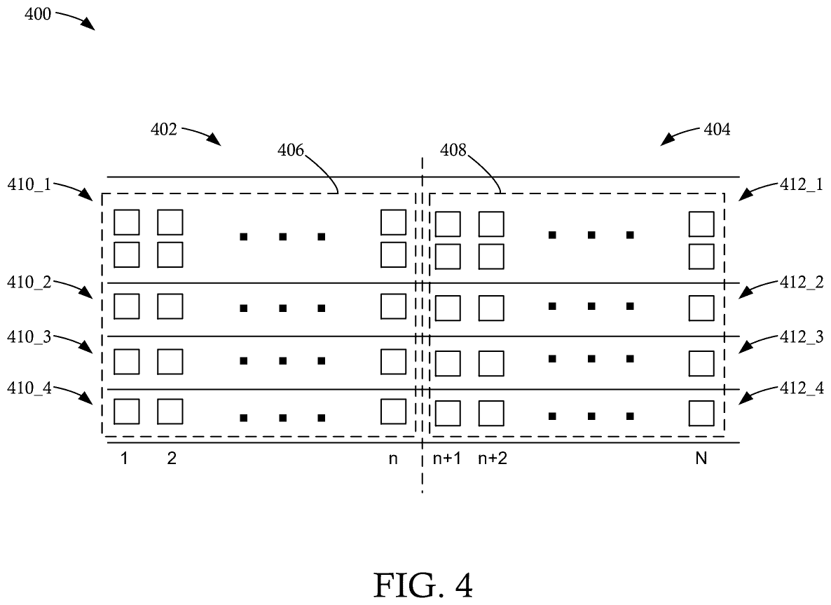

FIG. 4 illustrates an example time series feature set 400, in accordance with some embodiments. In some embodiments, a time series feature set 400 selected for generation (e.g., training) of a time series model includes similar time series elements for both a pre-campaign period 402 (e.g., a period of time prior to an interaction campaign) and a campaign period 404 (e.g., a period of time during the interaction campaign). The time series feature set 400 may be divided into a set of pre-campaign time series elements 406 corresponding to the pre-campaign period 402 and a set of campaign time series elements 408 corresponding to the campaign period 404. The set of pre-campaign time series elements 406 may be provided as an input to an untrained and/or partially trained time series model, which is iteratively adjusted to generate an output corresponding to the set of campaign time series elements 408. In some embodiments, pre-campaign input parameters (e.g., parameters 410_1, prediction 410_2, covariates 410_3, and observations 410_4 (collectively “input parameters 410”)) may be used to train a time series model such that the time series model learns patterns to match the pre-campaign time series elements 406 to the campaign time series elements 408. The input parameters 410 may be used to predict a counterfactual for a given time series set (e.g., the output of the trained time series model). In some embodiments, the input parameters 410 may identify a trend in time series elements by capturing a long-term underlying direction and/or tendency of the time series elements. The input parameters 410 may also account for one or more external covariates time series that may be used to predict a target time series. In some embodiments, irregular noise may be factored into the input parameters 410 to represent random or unpredictable variations in a time series received after deployment of the trained time series model.

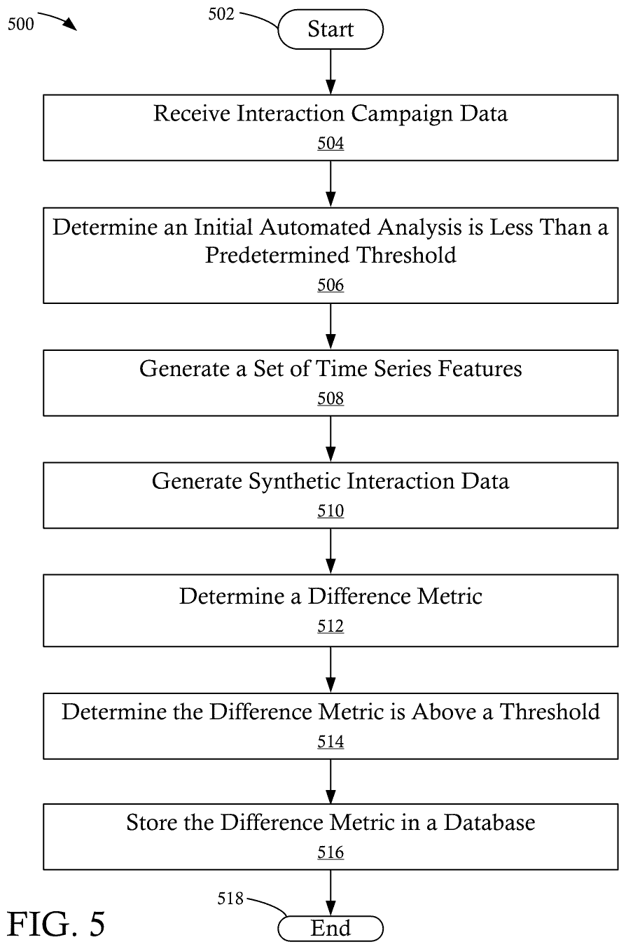

FIG. 5 is a flow diagram depicting an example method. In some embodiments, one or more blocks of the method may be executed substantially concurrently and/or in a different order than shown. In some implementations, a method may include more or fewer blocks than are shown. In some implementations, one or more of the blocks of a method may, at certain times, be ongoing and/or may repeat. In some implementations, blocks of the method may be combined.

The method shown in FIG. 5 may be implemented in the form of executable instructions stored on a machine-readable medium and executed by a processing resource and/or in the form of electronic circuitry. For example, aspects of the method may be described below as being performed by the hardware processing resources 104, 204 of the interaction analysis computing devices 102, 202 described above. Additionally, other aspects of the method described below may be described with reference to other elements shown in FIG. 1 and/or FIG. 2 for non-limiting illustration purposes.

FIG. 5 depicts a flowchart of an example method 500 for performing interaction analysis, in accordance with some embodiments. The method 500 begins at block 502 and continues to block 504, where interaction campaign data is received. The interaction campaign data may include analogous features to the interaction data 126 and 226 described with respect to FIGS. 1 and 2. Furthermore, the campaign interaction data may include time series elements representative of interactions with a user interface during a time period in which at least one user interface element associated with an interaction campaign was displayed on a user interface. In some embodiments, the time period coinciding with an interaction campaign is selected based on a time period coinciding with a classic or seasonal campaign as described with respect to FIGS. 1 and 2.

At block 506, an initial automated analysis is determined to be less than a predetermined threshold. An initial analyzer, such as initial analyzer 130, performs an analysis on interaction data to determine whether the analysis reaches a predetermined threshold. When the analysis does not reach the predetermined threshold, the interaction campaign data is identified for further processing. The predetermined threshold may be representative of accuracy metrics such that when the analysis includes data points having a distance more than a predetermined distance, the analysis will not meet the predetermined threshold.

At block 508, a set of time series features are generated. As discussed above with respect to FIGS. 1-3, time series features may be generated for a period of time before initiation of an interaction campaign (e.g., a pre-campaign period) and/or a period after an interaction campaign has been implemented (e.g., a campaign period). A time series feature may include an interaction rate (e.g., a click rate, add-to-cart rate, view rate) of a catalog item that is selected to be part of a campaign. Time series features may also include user interactions with catalog items, campaigns, etc.

At block 510, synthetic interaction data is generated. In some embodiments, the synthetic interaction data is generated for at least one interface element during at least the portion of the interaction campaign time period. As described in FIG. 1, the synthetic interaction data represents the counterfactual prediction for a plurality of users'behavior had the corresponding users not been exposed to a target interaction campaign. Additionally, the synthetic interaction data represents interactions with the at least one interface element independent of the interaction campaign and the synthetic interaction data is generated by a time series model that receives the set of time series features.

At block 512, a difference metric is determined. In some embodiments, the difference metric represents a delta between the counterfactual prediction and the actual interactions that occurred. The difference metric may further represent additional calculations or determinations regarding whether the interaction analysis is accurate.

At block 514, the difference metric is determined to be above a threshold and, at block 516, the difference metric data is stored in a database. As described in FIGS. 1-2, a threshold calculator may determine when the difference metric satisfies a predetermined threshold. The difference metrics, and corresponding time series features, that meet the predetermined threshold may be stored in the database. At block 518, the method 500 ends.

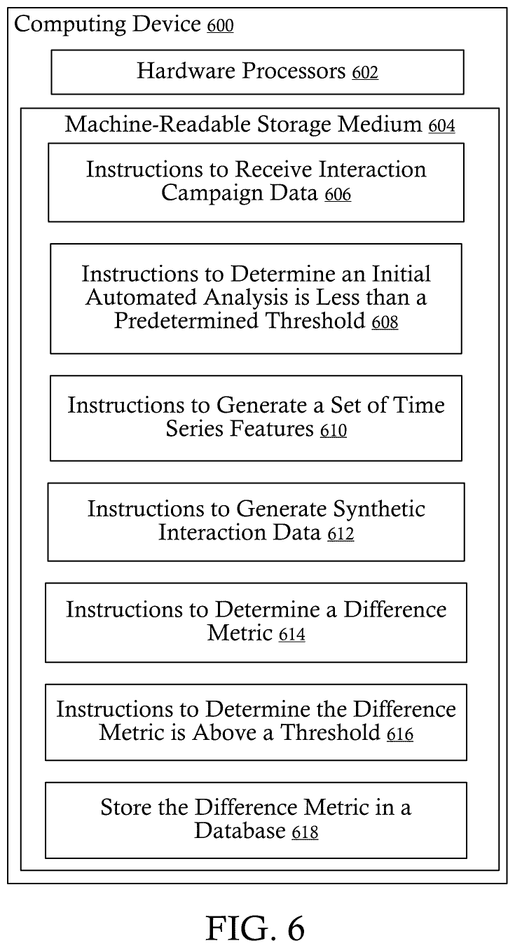

FIG. 6 depicts an example system 600 that includes a machine-readable storage media 604 encoded with example instructions executable by processing resource 602. In some implementations the system 600 may be useful for implementing aspects of the systems of FIGS. 1-3 or performing the aspects of method 500 of FIG. 5. For example, the instructions encoded on machine-readable storage media 604 may be included in instructions 108 of FIG. 1 and/or instructions 208 of FIG. 2. In some implementations, functionality described with respect to FIGS. 1 and/or 2 may be included in the instructions encoded on machine-readable storage media 604.

The processing resource 602 may include a microcontroller, a microprocessor, central processing unit core(s), an ASIC, an FPGA, and/or other hardware device suitable for retrieval and/or execution of instructions from the machine-readable storage media 604 to perform functions related to various examples. Additionally or alternatively, the processing resource 602 may include or be coupled to electronic circuitry or dedicated logic for performing some or all of the functionality of the instructions described herein.

The machine-readable storage media 604 may be any medium suitable for storing executable instructions, such as RAM, ROM, EEPROM, flash memory, a hard disk drive, an optical disc, or the like. In some example implementations, the machine-readable storage media 604 may be a tangible, non-transitory medium. The machine-readable storage media 604 may be disposed within a corresponding system 600 in which case the executable instructions may be deemed installed or embedded on the system. Alternatively, the machine-readable storage media 604 may be a portable (e.g., external) storage medium, and may be part of an installation package.

As described further herein below, the machine-readable storage media 604 may be encoded with a set of executable instructions. It should be understood that part or all of the executable instructions and/or electronic circuits included within one box may, in alternate implementations, be included in a different box shown in the figures or in a different box not shown. Some implementations may include more or fewer instructions than are shown in FIG. 6.

As shown in FIG. 6, the machine-readable storage media 604 includes instructions 606-616. Instructions 606, when executed, cause the processing resource 602 to receive interaction campaign data. The interaction campaign data may include analogous features to the interaction data 126, 226 described with respect to FIGS. 1 and 2. Furthermore, the campaign interaction data may include time series elements representative of interactions with a user interface during a time period in which at least one user interface element associated with an interaction campaign was displayed on a user interface. In some embodiments, the time period coinciding with an interaction campaign is selected based on a time period coinciding with a classic or seasonal campaign as described with respect to FIGS. 1 and 2.

Instructions 608, when executed, cause the processing resource 602 to determine that an output of an initial automated analysis is less than a predetermined threshold. An initial analyzer, such as initial analyzer 130, generates an output value based on an analysis of interaction data and determines whether the output value reaches a predetermined threshold. When the output value does not reach the predetermined threshold, the interaction campaign data is identified for further processing. The predetermined threshold may be representative of accuracy metrics such that an output value below the predetermined threshold indicates that data points of the corresponding time series have a distance greater than a predetermined distance.

Instructions 610, when executed, cause the processing resource 602 to generate a set of time series features. As discussed above with respect to FIGS. 1-3, time series features may be generated for a period of time before initiation of an interaction campaign (e.g., a pre-campaign period) and/or a period after an interaction campaign has been implemented (e.g., a campaign period). A time series feature may include an interaction rate (e.g., a click rate, add-to-cart rate, view rate) of a catalog item that is selected to be part of a campaign. Time series features may also include user interactions with catalog items, campaigns, etc.

Instructions 612, when executed, cause the processing resource 602 to generate synthetic interaction data. In some embodiments, the synthetic interaction data is generated for at least one interface element during at least the portion of the interaction campaign time period. As described in FIG. 1, the synthetic interaction data represents the counterfactual prediction for a plurality of users'behavior had the corresponding users not been exposed to a target interaction campaign. Additionally, the synthetic interaction data represents interactions with the at least one interface element independent of the interaction campaign and the synthetic interaction data is generated by a time series model that receives the set of time series features.

Instructions 614, when executed, cause the processing resource 602 to determine a difference metric. In some embodiments, the difference metric represents a delta between the counterfactual prediction and the actual interactions that occurred. The difference metric may further represent additional calculations or determinations regarding whether the interaction analysis is accurate.

Instructions 616, when executed, cause the processing resource 602 to determine a difference metric is above a threshold. Instructions 618, when executed, cause the processing resource 602 to store the difference metric in a database. As described in FIGS. 1-2, a threshold calculator may determine when the difference metric satisfies a predetermined threshold. The difference metrics, and corresponding time series features, that meet the predetermined threshold may be stored in the database.

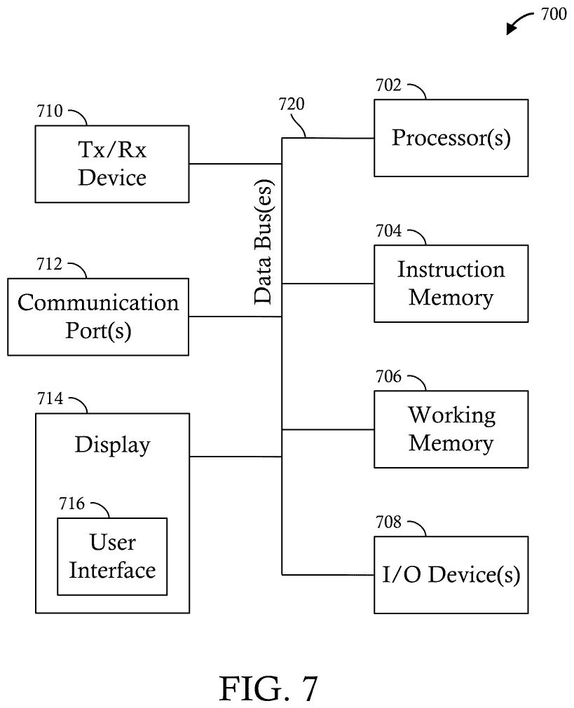

FIG. 7 illustrates a block diagram of a computing device 700, in accordance with some embodiments. Although FIG. 7 is described with respect to certain components shown therein, it will be appreciated that the elements of the computing device 700 may be combined, omitted, and/or replicated. In addition, it will be appreciated that additional elements other than those illustrated in FIG. 7 may be added to the computing device.

As shown in FIG. 7, the computing device 700 may include one or more processing resources 702, instruction memory 704, working memory 706, input/output devices 708, transceiver 710, communication port(s) 712, display 714, and/or any other suitable elements each operatively coupled to one or more data buses 720. The data buses 720 allow for communication among the various components. The data buses 720 may include wired, or wireless, communication channels.

The one or more processing resources 702 may include any processing circuitry operable to control operations of the computing device 700. In some embodiments, the one or more processing resources 702 include one or more distinct processors, each having one or more cores (e.g., processing circuits). Each of the distinct processors may have the same or different structure. The one or more processing resources 702 may include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processing resources 702 may also be implemented by a controller, a microcontroller, an application specific integrated circuit (ASIC), a field programmable gate array (FPGA), a programmable logic device (PLD), etc.

In some embodiments, the one or more processing resources 702 implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 704 may store instructions that are accessed (e.g., read) and executed by at least one of the one or more processing resources 702. For example, the instruction memory 704 may be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processing resources 702 may perform a certain function or operation by executing code, stored on the instruction memory 704, embodying the function or operation. For example, the one or more processing resources 702 may execute code stored in the instruction memory 704 to perform one or more of any function, method, or operation disclosed herein.

Additionally, the one or more processing resources 702 may store data to, and read data from, the working memory 706. For example, the one or more processing resources 702 may store a working set of instructions to the working memory 706, such as instructions loaded from the instruction memory 704. The one or more processing resources 702 may also use the working memory 706 to store dynamic data created during one or more operations. The working memory 706 may include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 704 and working memory 706, it will be appreciated that the computing device 700 may include a single memory unit that operates as both instruction memory and working memory. Further, although embodiments are discussed herein including non-volatile memory, it will be appreciated that computing device 700 may include volatile memory components in addition to at least one non-volatile memory component.

In some embodiments, the instruction memory 704 and/or the working memory 706 includes an instruction set, in the form of a file for executing various methods, such as methods for generating an interaction analysis, as described herein. The instruction set may be stored in any acceptable form of machine-readable instructions, including source code or various appropriate programming languages. Some examples of programming languages that may be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter converts the instruction set into machine executable code for execution by the one or more processing resources 702.

The input/output devices 708 may include any suitable device that allows for data input or output. For example, the input/output devices 708 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 710 and/or the communication port(s) 712 allow for communication with a network. For example, if a communication network is a cellular network, the transceiver 710 allows communications with the cellular network. In some embodiments, the transceiver 710 is selected based on the type of the communication network the computing device 700 will be operating in. The one or more processing resources 702 are operable to receive data from, or send data to, a network, via the transceiver 710.

The communication port(s) 712 may include any suitable hardware, software, and/or combination of hardware and software that is capable of coupling the computing device 700 to one or more networks and/or additional devices. The communication port(s) 712 may be arranged to operate with any suitable technique for controlling information signals using a desired set of communications protocols, services, or operating procedures. The communication port(s) 712 may include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 712 allows for the programming of executable instructions in the instruction memory 704. In some embodiments, the communication port(s) 712 allow for the transfer (e.g., uploading or downloading) of data, such as machine learning model training data.

In some embodiments, the communication port(s) 712 couples the computing device 700 to a network. The network may include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments may include in-body communications, various devices, and various modes of communications such as wireless communications, wired communications, and combinations of the same.

In some embodiments, the transceiver 710 and/or the communication port(s) 712 utilize one or more communication protocols. Examples of wired protocols may include, but are not limited to, Universal Serial Bus (USB) communication, RS-232, RS-422, RS-423, RS-485 serial protocols, FireWire, Ethernet, Fiber Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols may include, but are not limited to, the Institute of Electrical and Electronics Engineers (IEEE) 702.xx series of protocols, such as IEEE 702.11a/b/g/n/ac/ag/ax/be, IEEE 702.16, IEEE 702.20, GSM cellular radiotelephone system protocols with GPRS, CDMA cellular radiotelephone communication systems with 1xRTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 714 may be any suitable display and may display the user interface 716. The user interfaces 716 may enable user interaction with the generated interaction analysis. For example, the user interface 716 may be a user interface for an application of a network environment operator that allows a user to view and interact with the operator's website. In some embodiments, a user may interact with the user interface 716 by engaging the input/output devices 708. In some embodiments, the display 714 may be a touchscreen, where the user interface 716 is displayed on the touchscreen.

The display 714 may include a screen such as, for example, a Liquid Crystal Display (LCD) screen, a light-emitting diode (LED) screen, an organic LED (OLED) screen, a movable display, a projection, etc. In some embodiments, the display 714 may include a coder/decoder, also known as Codecs, to convert digital media data into analog signals. For example, the visual peripheral output device may include video Codecs, audio Codecs, or any other suitable type of Codec.

In some embodiments, the computing device 700 implements one or more modules or engines, each of which is constructed, programmed, configured, or otherwise adapted, to autonomously carry out a function or set of functions. A module/engine may include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality that (while being executed) transform the microprocessor system into a special-purpose device. A module/engine may also be implemented as a combination of the two, with certain functions facilitated by hardware alone, and other functions facilitated by a combination of hardware and software. In certain implementations, at least a portion, and in some cases, all, of a module/engine may be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine may be realized in a variety of physically realizable configurations, and should generally not be limited to any particular example implementation herein, unless such limitations are expressly called out. In addition, a module/engine may itself be composed of more than one sub-module or sub-engine, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

In some embodiments, the computing device 700 may be a computer, a workstation, a laptop, a server such as a cloud-based server, or any other suitable device. In some embodiments, the computing device 700 is a server that includes one or more processing units, such as one or more graphical processing units (GPUs), one or more central processing units (CPUs), and/or one or more processing cores. The computing device 700 may, in some embodiments, execute one or more virtual machines. In some embodiments, processing resources (e.g., capabilities) of the computing device 700 are offered as a cloud-based service (e.g., cloud computing).

In one non-limiting example implementation of disclosed systems and methods, a counterfactual prediction is used to validate or verify a report output, such as a sales lift report, and provides the verified report as an output to a user. For example, during a campaign designed to promote catalog items for Halloween, interaction data between customers and catalog items flagged for the campaign may be recorded. A user may request a sales lift report that provides an analysis of how successful or effective the campaign is (when the campaign is on-going) or was (when the campaign has completed). In some embodiments, data for customers who had interactions with catalog items (e.g., exposed users) during the corresponding campaign are analyzed and a counterfactual prediction including synthetic unexposed user data is generated. The synthetic unexposed data is compared to the exposed (e.g., actual) to verify the sales lift report is appropriate for providing to the requesting user. Applying a time series model to generate the counterfactual prediction removes variables that would be associated with bringing in data that is based on different customers interactions with the same catalog items that were not exposed to the campaign. In the foregoing example embodiment, applying the time series model to generate a counterfactual prediction for exposed users provides a more accurate analysis of the effectiveness of a corresponding campaign.

Although embodiments are illustrated herein including certain systems and/or devices, it will be appreciated that additional systems, servers, storage mechanism, etc. may be included. In addition, although embodiments are illustrated herein having individual, discrete systems, it will be appreciated that, in some embodiments, one or more systems may be combined into a single logical and/or physical system. Similarly, although embodiments are illustrated having a single instance of each device or system, it will be appreciated that additional instances of a device may be implemented. In some embodiments, two or more systems may be operated on shared hardware in which each system operates as a separate, discrete system utilizing the shared hardware, for example, according to one or more virtualization schemes.

Although the subject matter has been described in terms of example embodiments, it is not limited thereto. Rather, the appended claims should be construed broadly, to include other variants and embodiments that may be made by those skilled in the art.

What is claimed is:

1. A system, comprising:
a processor; and
a non-transitory memory storing instructions, that when executed, cause the processor to:
receive interaction data for at least one interface element included in a user interface during a time period coinciding with an interaction campaign;
determine whether at least one initial analysis metric for an initial automated analysis of the interaction data meets or exceeds a first predetermined threshold;
responsive to determining that the at least one initial analysis metric for the interaction data is below the first predetermined threshold:
generate a set of time series features for at least a portion of the time period;
generate synthetic interaction data for the at least one interface element during at least the portion of the time period, wherein the synthetic interaction data represents interactions with the at least one interface element independent of the interaction campaign, and wherein the synthetic interaction data is generated by a time series model that receives the set of time series features;
generate a difference metric for the interaction data and the synthetic interaction data;
determine whether the difference metric meets or exceeds a second predetermined threshold; and
responsive to determining the difference metric meets or exceeds the second predetermined threshold, store the difference metric in a database.

2. The system of claim 1, wherein the time series model produces the synthetic interaction data based on a determined representation to convert exposed users into unexposed users, wherein exposed users comprise users who are exposed to the interaction campaign and the unexposed users comprise users who are not exposed to the interaction campaign.

3. The system of claim 1, wherein the difference metric for the interaction data and the synthetic interaction data is an output of a difference calculator that includes multiple calculations between synthetic interaction data and interaction data including one or more of a matching quality, a curve drop, a maximum gap, or a ratio of any two.

4. The system of claim 3, wherein the difference calculator determines a difference of actual interactions stored in exposed feature data and an output of the time series model, and wherein the time series model includes applying a counterfactual prediction model to the exposed feature data.

5. The system of claim 1, wherein input parameters are used to predict a counterfactual for a given time series set by identifying a trend in time series elements to capture a long-term underlying direction of time series elements.

6. The system of claim 5, wherein the input parameters accounts for one or more external covariates time series that are used to predict a target time series.

7. The system of claim 1, wherein the set of time series features include an interaction rate of a catalog item that is selected to be part of the interaction campaign.

8. A computer-implemented method, comprising:
receiving interaction data for at least one interface element included in a user interface during a time period coinciding with an interaction campaign;
determining whether at least one initial analysis metric for an initial automated analysis of the interaction data is meets or exceeds a first predetermined threshold;
responsive to determining that the at least one initial analysis metric for the interaction data is below the first predetermined threshold:
generating a set of time series features for at least a portion of the time period;
generating synthetic interaction data for the at least one interface element during at least the portion of the time period, wherein the synthetic interaction data represents interactions with the at least one interface element independent of the interaction campaign, and wherein the synthetic interaction data is generated by a time series model that receives the set of time series features;
generating a difference metric for the interaction data and the synthetic interaction data;
determining whether the difference metric meets or exceeds a second predetermined threshold; and
responsive to determining the difference metric meets or exceeds the second predetermined threshold, storing the difference metric in a database.

9. The method of claim 8, wherein the time series model produces the synthetic interaction data based on a determined representation to convert exposed users into unexposed users, wherein exposed users comprise users who are exposed to the interaction campaign and the unexposed users comprise users who are not exposed to the interaction campaign.

10. The method of claim 8, wherein the difference metric for the interaction data and the synthetic interaction data is an output of a difference calculator that includes multiple calculations between synthetic interaction data and interaction data including one or more of a matching quality, a curve drop, a maximum gap, or a ratio of any two.

11. The method of claim 10, wherein the difference calculator determines a difference of actual interactions stored in exposed feature data and an output of the time series model, and wherein the time series model includes applying a counterfactual prediction model to the exposed feature data.

12. The method of claim 8, wherein input parameters are used to predict a counterfactual for a given time series set by identifying a trend in time series elements to capture a long-term underlying direction of time series elements.

13. The method of claim 12, wherein the input parameters accounts for one or more external covariates time series that are used to predict a target time series.

14. The method of claim 8, wherein the set of time series features include an interaction rate of a catalog item that is selected to be part of the interaction campaign.

15. A non-transitory computer readable medium having instructions stored thereon, wherein the instructions, when executed by at least one processor, cause at least one device to perform operations comprising:
receiving interaction data for at least one interface element included in a user interface during a time period coinciding with an interaction campaign; determining whether at least one initial analysis metric for an initial automated analysis of the interaction data is meets or exceeds a first predetermined threshold;
responsive to determining that the at least one initial analysis metric for the interaction data is below the first predetermined threshold:
generating a set of time series features for at least a portion of the time period;
generating synthetic interaction data for the at least one interface element during at least the portion of the time period, wherein the synthetic interaction data represents interactions with the at least one interface element independent of the interaction campaign, and wherein the synthetic interaction data is generated by a time series model that receives the set of time series features;
generating a difference metric for the interaction data and the synthetic interaction data;
determining whether the difference metric meets or exceeds a second predetermined threshold; and
responsive to determining the difference metric meets or exceeds the second predetermined threshold, storing the difference metric in a database.

16. The non-transitory computer readable medium of claim 15, wherein the time series model produces the synthetic interaction data based on a determined representation to convert exposed users into unexposed users, wherein exposed users comprise users who are exposed to the interaction campaign and the unexposed users comprise users who are not exposed to the interaction campaign.

17. The non-transitory computer readable medium of claim 15, wherein the difference metric for the interaction data and the synthetic interaction data is an output of a difference calculator that includes multiple calculations between synthetic interaction data and interaction data including one or more of a matching quality, a curve drop, a maximum gap, or a ratio of any two.

18. The non-transitory computer readable medium of claim 17, wherein the difference calculator determines a difference of actual interactions stored in exposed feature data and an output of the time series model, and wherein the time series model includes applying a counterfactual prediction model to the exposed feature data.

19. The non-transitory computer readable medium of claim 15, wherein input parameters are used to predict a counterfactual for a given time series set by identifying a trend in time series elements to capture a long-term underlying direction of time series elements.

20. The non-transitory computer readable medium of claim 15, wherein the set of time series features include an interaction rate of a catalog item that is selected to be part of the interaction campaign.
